(19) United States
(12) Patent Application Publication
(10) Pub. No.: US 2021/0395915 A1
(43) Pub. Date: Dec. 23, 2021

(54) METHOD FOR REMOVING METAL SUPPORTING STRUCTURES ON AN ADDITIVELY MANUFACTURED METAL COMPONENT

(71) Applicant: RENA TECHNOLOGIES AUSTRIA GMBH, Hirtenberg (AT)

(72) Inventors: Selma HANSAL, Markt Piesting (AT); Wolfgang HANSAL, Markt Piesting (AT); Gabriela SANDULACHE, Berndorf (AT)

(21) Appl. No.: 17/285,610

(22) PCT Filed: Oct. 18, 2019
(86) PCT No.: PCT/EP2019/078418

§ 371 Date: Apr. 15, 2021

(30) Foreign Application Priority Data
Oct. 18, 2018 (EP) 18201350.8

(51) Int. Cl. C25F 3/08; B22F 3/24; B22F 10/43; C25F 3/04; C25F 3/06

(52) U.S. Cl. CPC C25F 3/08; B22F 3/24; B33Y 40/20; C25F 3/04; C25F 3/06; B22F 10/43

(57) ABSTRACT

A process for removing metallic support structures, sinter cakes and/or discharge lugs on an additively manufactured metal component, wherein the metal component is treated electrolytically in an acidic electrolyte, the metal component being operated as an anode for a defined period of time, wherein, during the defined period of time, a higher voltage and then a lower voltage or a higher current density and then a lower current density are alternately applied to the metal component multiple times.

The present invention relates to a process for removing metallic support structures, sinter cakes and/or discharge lugs on an additively manufactured metal component, wherein the metal component is treated electrolytically in an acidic electrolyte, the metal component being operated as an anode for a defined period of time. Furthermore, the invention relates to an electrolytic cell comprising an acidic electrolyte.

### BACKGROUND OF THE INVENTION

In additive manufacturing methods for the production of metal components such as selective laser sintering, selective laser melting or selective electron beam melting, metal powder layers are selectively solidified using the energy of a laser or electron beam. Using such manufacturing methods, complex metal components can, in principle, be manufactured, wherein, depending on the geometric shape, support structures that will remain behind are necessary. Depending on the manufacturing conditions, a sinter cake may also remain on the metal component. So as to avoid high temperature gradients during manufacture, the raw metal component is equipped occasionally, during additive manufacturing, with discharge lugs for dissipating heat in appropriate component regions.

Those support structures and residues, which are undesirable in the finished component, have to be removed in a complicated manner after the metal component has been manufactured, wherein electrochemical processes such as electropolishing processes are used in addition to mechanical processes such as milling, vibratory grinding and the use of blasting agents, especially for complex metal components.

GB 2 543 058 A1 describes an electrochemical process for smoothing a metal component which has been manufactured additively, wherein very high electrical voltages are used and different electrolytes made of inorganic salts, inorganic acids or inorganic bases are added in an amount of up to 25% by weight.

The selectivity of the process described in GB 2 543 058 is low, however. Irregularities on the metal component are indeed smoothed sufficiently, but the controllability of the material removal turns out to be difficult.

WO 2018/102845 A1 describes an electropolishing process for an additively manufactured metal component using methanesulfonic acid and phosphonic acid. Minor irregularities resulting from the manufacturing method are thereby smoothed. In WO 2018/102844 A1, an electropolishing process for an additively manufactured metal component is described, with a steady increase in current strength being provided. A mechanical pretreatment of support structures is described both in WO 2018/102845 A1 and in WO 2018/102844 A1. It is not possible to remove such auxiliary structures. Another electropolishing process is described in EP 3 388 172 A1. All those electropolishing processes are used for smoothing production-related irregularities on the surface. Support structures, sinter cakes or discharge lugs are not removed with those methods.

### BRIEF DESCRIPTION OF THE INVENTION

Therefore, it is the object of the present invention to provide a process of the initially described type by means of which support structures, sinter cakes or discharge lugs can be removed selectively on the additively manufactured metal component.

This object is achieved by a process for removing metallic support structures, sinter cakes and/or discharge lugs on an additively manufactured metal component, wherein the metal component is treated electrolytically in an acidic electrolyte, the metal component being operated as an anode for a defined period of time, characterized in that, during the defined period of time, a higher voltage and then a lower voltage or a higher current density and then a lower current density are alternately applied to the metal component multiple times.

It has surprisingly been found that, by alternately applying higher and lower voltages and current densities, respectively, disruptive structures such as the sinter cake, the support structures or discharge lugs can be removed on the metal component in a more controlled manner so that the actual metal component itself will be attacked less.

Preferably, the entire duration of the treatment lasts between 10 and 120, preferably between 20 and 70 minutes, particularly preferably from 30 to 60 minutes.

It has surprisingly been found that applying the higher voltage for a short period of time is sufficient. Specifically, it has been shown that a duration of not more than 20 s, preferably not more than 5 s, is sufficient.

It was even more surprising that applying different currents for even shorter periods of time was sufficient. Durations of less than 1 s might already be sufficient in this case.

With the present process, both the higher and the lower voltages/currents can be kept significantly lower than in GB 2 543 058 A1. For example, the lower voltage may be not more than 30 V, preferably not more than 10 V. For example, the higher voltage may be not more than 60 V, preferably not more than 40 V.

The electrolyte must be configured to be acidic. Particularly good results have been achieved with the acidic electrolyte containing at least one halide, in particular chloride or fluoride. Chloride is suited particularly well for metal components made of iron (alloys), while fluoride shows good results in all metal components. The latter is preferably added in the form of dissolved HF₂⁻, preferably NH₄HF₂. HF₂⁻ is preferably added to the electrolyte in an amount of between 0.5 and 1 mol/l, preferably from 0.6 to 1.8 mol/l. Consequently, the concentration of F⁻ preferably ranges between 1 and 2 mol/l, preferably from 1.2 to 1.6 mol/l.

It is also advantageous if the acidic electrolyte contains a sulfate or sulfonate. The sulfate can be added, for example, in the form of sulfuric acid or a salt thereof. Methylsulfonic acid or a salt thereof is considered, for example, as the sulfonate.

The electrolyte preferably contains a strong acid. Preferred examples are sulfuric acid or nitric acid.

The electrolyte preferably contains at least 30% by volume of an acid.

The process has turned out to be particularly suitable for metal components and metallic support structures made of titanium or a titanium alloy. An example of a suitable alloy would be TiAl6V4. Other metals that are also suitable include aluminium alloys, nickel-based alloys (preferably Inconel) or iron alloys.

In any case, it is preferably provided that sinter cakes, support structures and the metal component are made of the same metal.

The invention is explained in further detail by way of examples and comparative examples. What applies to all examples is that the support structure, the sinter cake or the discharge lugs were completely removed after the treatment, while the geometry of the metal component itself was fully preserved.

### Example 1

Removal of Support Structures from a Metal Component made of a Titanium Alloy TiAl6V4 (LPBF)

A metal component made of the alloy TiAl6V4 (LPBF) was placed in an electrolyte upon additive manufacture and was operated as an anode. The electrolyte used was:
60% by volume of water
40% by volume of H₂SO₄
33.3 g/l NH₄HF₂

Over a period of 30 min at room temperature, the voltage at the anode was changed as follows:
1 s at 5 V
1 s at 25 V
alternately.

### Example 2

Removal of Support Structures from a Metal Component made of a Titanium Alloy TiAl6V4 (EBM)

A metal component made of the alloy TiAl6V4 (EBM) was placed in an electrolyte upon additive manufacture and was operated as an anode. The electrolyte used was:
60% by volume of water
40% by volume of H₂SO₄
33.3 g/l NH₄HF₂

Step 1: The metal component was electrolyzed at 5 V for 30 minutes.

Step 2: Over a period of 5 min at room temperature, the voltage at the metal component was changed as follows:

14 s at 5 V
1 s at 35 V
alternately.

### Example 3

Removal of Support Structures from a Metal Component made of a Titanium Alloy TiAl6V4 (LPBF)

A metal component made of the alloy TiAl6V4 (LPBF) was placed in an electrolyte upon additive manufacture and was operated as an anode. The electrolyte used was:
60% by volume of water
40% by volume of H₂SO₄
33.3 g/l NH₄HF₂

Step 1: The metal component was electrolyzed at 5 V for 30 minutes.

Step 2: Over a period of 5 min at room temperature, the voltage at the metal component was changed as follows:
4 s at 5 V
1 s at 35 V
alternately.

### Example 4

Removal of the Sinter Cake and the Support Structures from a Metal Component made of a Titanium Alloy TiAl6V4 (EBM)

A metal component made of the alloy TiAl6V4 (EBM) was placed in an electrolyte upon additive manufacture and was operated as an anode. The electrolyte used was:
60% by volume of water
40% by volume of H₂SO₄
33.3 g/l NH₄HF₂

Over a period of 30 min at room temperature, the voltage at the anode was changed as follows:
4 s at 5 V
1 s at 25 V
alternately.

### Example 5

Removal of the Sinter Cake and the Support Structures from a Metal Component made of a Titanium Alloy TiAl6V4 (LPBF)

A metal component made of the alloy TiAl6V4 (LPBF) was placed in an electrolyte upon additive manufacture and was operated as an anode. The electrolyte used was:
60% by volume of water
40% by volume of H₂SO₄
33.3 g/l NH₄HF₂

Over a period of 60 min at room temperature, the voltage at the anode was changed as follows:
4 s at 5 V
1 s at 25 V
alternately.

### Example 6

Removal of the Sinter Cake from a Metal Component made of a Titanium Alloy TiAl6V4 (EBM)

Upon additive manufacture, a metal component made of the alloy TiAl6V4 (EBM) was pretreated at room temperature in a solution in a currentless manner for 20 minutes. The solution contained the following ingredients.
20% by volume of HNO₃
5% by volume of hydrofluoric acid

Step 2: The pretreated metal component was electrolyzed electrolytically in an electrolyte of the composition
60% by volume of water
40% by volume of H₂SO₄
50 g/l NH₄HF₂

at room temperature at
4 s at 5 V
1 s at 25 V

alternately for 20 minutes.

### Example 7

Removal of Adhering Powder Residues from a Metal Component made of an Aluminium Alloy AlSi10 Mg (LPBF)

A metal component made of the alloy AlSi10 Mg (LPBF) was placed in an electrolyte upon additive manufacture and was operated as an anode. The electrolyte used was:
50% by volume of methanesulfonic acid
50% by volume of ethylene glycol
27 g/l NH₄HF₂

For 30 minutes at 65° C., the current density at the anode was changed as follows:
10 ms at 3 A/dm²
10 ms at 9 A/dm²

### Example 8

Removal of Adhering Powder Residues from a Metal Component made of an Aluminium Alloy AlSi10 Mg (LPBF)

A metal component made of the alloy AlSi10 Mg (LPBF) was placed in an electrolyte upon additive manufacture and was operated as an anode. The electrolyte used was:
50% by volume of methanesulfonic acid
50% by volume of 1,2-propanediol
27 g/l NH₄HF₂

For 30 minutes at 65° C., the current density at the anode was changed as follows:
10 ms at 3 A/dm²
10 ms at 9 A/dm₂

### Example 9

Removal of Support Structures from a Metal Component made of a Nickel-Based Alloy Inconel 718® (LPBF)

A metal component made of the nickel-based alloy Inconel 718® (LPBF) was placed in an electrolyte upon additive manufacture and was operated as an anode. The electrolyte used was:
50% by volume of water
12.5% by volume of HNO₃ 53%
37.5% by volume of HCl 32%

For 7 minutes, the potential at the anode was changed as follows:
1000 ms at 20 V
4000 ms at 3 V

### Example 10

Removal of Support Structures from a Metal Component made of Stainless Steel 316L (LPBF)

A metal component made of stainless steel 316L (LPBF) was placed in an electrolyte upon additive manufacture and was operated as an anode. The electrolyte used was:
50% by volume of water
12.5% by volume of HNO₃ 53%
37.5% by volume of HCl 32%

For 7 minutes, the potential at the anode was changed as follows:
1000 ms at 20 V
4000 ms at 3 V

### Example 11

Removal of Support Structures from a Metal Component made of the Aluminium Alloy AlSi10Mg (LPBF)

A metal component made of the aluminium alloy AlSi10Mg (LPBF) was placed in an electrolyte upon additive manufacture and was operated as an anode. The electrolyte used was:
60% by volume of water
40% by volume of H₂SO₄
50 g/l NH₄HF₂

For 10 minutes, the potential at the anode was changed as follows:
1000 ms at 20 V.
4000 ms at 3 V.

Annotation:

LPBF: metal component produced by laser powder bed fusion

EBM: metal component produced by electron beam melting

1. A process for removing metallic support structures, sinter cakes and/or discharge lugs on an additively manufactured metal component, wherein, during the process, the metal component is treated electrolytically in an acidic electrolyte, the metal component being operated as an anode for a defined period of time, characterized in that, during the defined period of time, a higher voltage and then a lower voltage or a higher current density and then a lower current density are alternately applied to the metal component multiple times.

2. A process according to claim 1, wherein the entire duration lasts from 10 to 120 minutes.

3. A process according to claim 1, wherein the higher voltage or current density is applied for a period of time of not more than 30 s.

4. A process according to claim 1, wherein the lower voltage is not more than 30 V and, respectively, the lower current density is not more than 7.

5. A process according to claim 1, wherein the higher voltage is not more than 60 V and, respectively, the higher current density is not more than 15 A/dm².

6. A process according to claim 1, wherein the acidic electrolyte contains Cl⁻ and/or F⁻.

7. A process according to claim 1, wherein the acidic electrolyte contains a sulfate or sulfonate.

8. A process according to claim 1, wherein the metal component and the metallic support structures, the sinter cake and the discharge lug are made of titanium or a titanium alloy, an aluminium alloy, a nickel-based alloy or an iron alloy.

9. An electrolytic cell comprising an acidic electrolyte in which an additively manufactured metal component with metallic support structures, a sinter cake and/or discharge lugs is located and forms the anode, wherein a control device is provided by means of which a higher voltage and then a lower voltage or a higher current density and then a lower current density are alternately applied to the anode multiple times for a defined period of time.

10. An electrolytic cell according to claim 9, characterized in that the electrolytic cell can be connected to a voltage source, with the control device being programmed such that the voltage applied to the anode is alternately increased and then reduced at the anode multiple times for a defined period of time or the current density is increased and then reduced.

11. A process according to claim 1, wherein the entire duration lasts from 20 to 70 minutes.

12. A process according to claim 1, wherein the higher voltage or current density is applied for a period of time of not more than 5 s.

13. A process according to claim 1, wherein the lower voltage is not more than 10 V and, respectively, the lower current density is not more than 4 A/dm².

14. A process according to claim 1, wherein the higher voltage is not more than 40 V and, respectively, the higher current density is not more than 10 A/dm².

15. A process according to claim 1, wherein the acidic electrolyte is in the form of dissolved NH₄HF₂.
